(19) United States
(12) Patent Application Publication
(10) Pub. No.: US 2021/0049036 A1
(43) Pub. Date: Feb. 18, 2021

(54) Capability Space

(71) Applicant: Facebook Technologies, LLC, Menlo Park, CA (US)

(72) Inventors: Bernhard Poess, Redmond, WA (US); Vadim Victor Spivak, Redwood City, CA (US); Marc Ihaab Salem, Sunnyvale, CA (US)

(21) Appl. No.: 16/539,901

(22) Filed: Aug. 13, 2019

(51) Int. Cl. G06F 9/46

(52) U.S. Cl. CPC G06F 9/468

(57) ABSTRACT

In one embodiment, a kernel of an operating system executing on a computing system receives a system call from a process requesting to perform an operation on a kernel object. The system call includes an object handle to the kernel object. The kernel accesses, from a memory space allocated to the kernel, data associated with the object handle. The data identifies an object type of the kernel object and specifies a bit string. The kernel identifies, based on the object type and the bit string, a list of capabilities of the process. The kernel determines whether the process has permission to perform the operation on the kernel object by comparing the operation to the list of capabilities. The kernel, in response to determining the process has permission to perform the operation, allows the operation on the kernel object to be performed.

### TECHNICAL FIELD

This disclosure generally relates to handles used in an operating system.

### BACKGROUND

In computer programming, a handle is an abstract reference to a resource. Handles are used when application software references blocks of memory or objects managed by another system, such as a database or an operating system. A resource handle can be an opaque identifier, in which case it is often an integer number (often an array index in an array or “table” that is used to manage that type of resource), or it can be a pointer that allows access to further information. Common resource handles are file descriptors, network sockets, database connections, process identifiers (PIDs), and job IDs. Process IDs and job IDs are explicitly visible integers, while file descriptors and sockets (which are often implemented as a form of file descriptor) are represented as integers, but are typically considered opaque. In traditional implementations, file descriptors are indices into a (per-process) file descriptor table, thence a (system-wide) file table.

### SUMMARY OF PARTICULAR EMBODIMENTS

Disclosed herein are a variety of different ways of generating handles for objects in an operating system. In particular embodiments, the handles may be specific for objects in an operating system for an augmented reality or virtual reality environment. The use of an augmented reality system or virtual reality system may be different than a typical computing system. As such, there may be privacy and security concerns that are unique to an augmented reality system or virtual reality system. Additionally, augmented reality systems and virtual reality systems may have different performance requirements than the typical computing system. As an example and not by way of limitation, an augmented reality system or a virtual reality system may have large memory requirements and large power consumption associated with rendering elements for display to a user. One goal of the disclosed methods may be to reduce the aggregated memory requirement and in turn to conserve power consumption through generating handles. Currently objects in an operating system may typically be referenced by handles that include a list of predetermined capabilities for all objects. The disclosed methods may generate handles that are specific to whether or not is has capabilities to a particular object type. Thereby eliminating the unnecessary bits associated with capabilities for object types other than the object type of the object. To do so, a kernel of the operating system may encode an object type into the object handle. When the kernel receives a system call from a process to perform an operation, the kernel may determine the object type from an object handle and confirm the capabilities of the process for the given object type based on a bit string of the object handle. In particular embodiments, the kernel may determine whether the process has permission to perform the operation and either allow or deny the process to perform the operation.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example operating system environment associated with a virtual reality system.

FIG. 2 illustrates an example object handle and its corresponding handle table.

FIG. 3 illustrates another example object handle and its corresponding handle table.

FIG. 4 illustrates another example object handle and its corresponding handle table.

FIG. 5 illustrates an example network environment associated with a virtual reality system.

FIG. 6 illustrates an example method for handling a system call from a process.

FIG. 7 illustrates an example computer system.

### DESCRIPTION OF EXAMPLE EMBODIMENTS

Each object in an operating system may be referenced by handles. In particular embodiments, to improve upon security, capability restrictions may be attached to each handle (e.g., read only, read/write, etc.). Initially, a handle to an object (e.g., a thread) may first be created with full capabilities. Later on, when the handle is transferred to another process, a subset of the capabilities may be granted to the recipient. A naive approach for encoding capabilities may be for each handle to store a list of bits that correspond to a list of predetermined capabilities for all objects (e.g., a 1 means the handle has the corresponding capability). However, since every handle needs such a list, the aggregated memory requirement could be large. This in turn may mean more power consumption, which is problematic for virtual reality (VR) and augmented reality (AR) devices.

In particular embodiments, in order to reduce the aggregated memory requirement and in turn to conserve power consumption, each handle may be encoded differently. Instead of having the full list of possible capabilities encoded within every handle, each handle may encode the capabilities that are relevant to its object type. As an example and not by way of limitation, if the handle is to a thread, it may encode whether or not it has capabilities related to threads; if the handle is to a process, it may encode whether it has capabilities related to processes. So for each handle, it may encode a capability type (e.g., thread vs. process) and bits that correspond to capabilities that are available for that type. In particular embodiments, object types may include a thread, a process, and an interrupt. In particular embodiments, capabilities may include the right to suspend a thread, the right to resume a thread, the right to query a process, the right to terminate a process, and the like. In particular embodiments, each handle may include a magic, a generation, and an offset. A magic may be a number that is hard to guess to improve upon the security of the handles. A generation may be a number to detect the offset. An offset may be a number to prevent replication of the handle.

In particular embodiments, upon generation of an object, a kernel of an operating system may generate a handle for a process. In particular embodiments, the kernel may define the capabilities the process has. In particular embodiments, the defining of the rights may be determined based on what rights a process requires in order to function. The kernel may have the ability to duplicate handles. Handles may be duplicated by taking the handle and a mask. Handles may be transferred from various processes. The reduced size of the handles may reduce memory/cache requirements, may reduce power consumption, and may increase the speed of capability validation for each object.

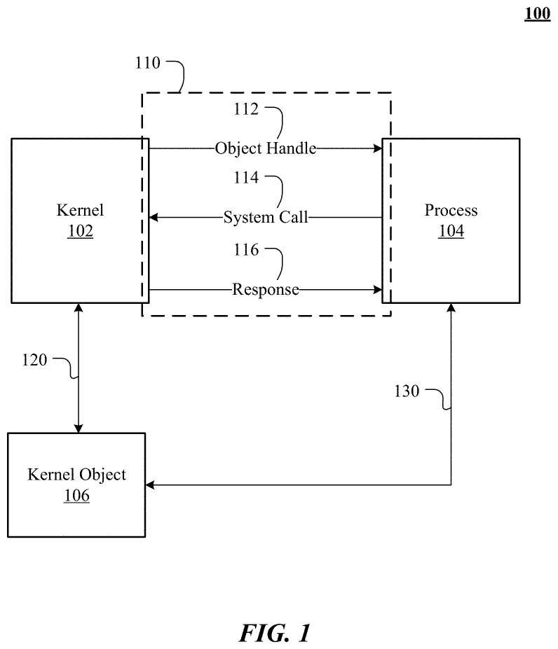

Referring to FIG. 1, an example operating system environment 100 is shown. The operating system environment 100 may comprise a kernel 102, a process 104, and a kernel object 106. In particular embodiments, the kernel 102 and the process 104 may communicate through a link 110. In particular embodiments, the link 110 may include various communications sent back and forth between the kernel 102 and the process 104. In particular embodiments, the kernel 102 and the kernel object 106 may communicate through a link 120. In particular embodiments, the process 104 and the kernel object 106 may communicate through a link 130. In particular embodiments, the kernel 102 may generate the kernel object 106. In particular embodiments, the kernel 102 may generate an object handle 112 to send to the process 104 through an interaction. As an example and not by way of limitation, the process 104 may initially request for an object handle 112. As another example and not by way of limitation, the kernel 102 may generate the object handle upon generation of the kernel object 106 and send the object handle 112 to the process 104. In particular embodiments, the object handle may comprise data that identifies an object type of a kernel object and specifies a bit string. As an example and not by way of limitation, the object handle 112 may comprise data that identifies the object type of the kernel object 106 and specifies a bit string. The bit string may be any number of bits long. In particular embodiments, data that identifies the object type may be another bit string. As an example and not by way of limitation, a thread object type may be specified by the bit string “1010.”

In particular embodiments, the process 104 may send a system call 114 to the kernel 102. The system call 114 may be a request to perform an operation on the kernel object 106. In particular embodiments, the operation may be one of a suspend operation, a resume operation, a query operation, a terminate operation, or the like. In particular embodiments, there may be specific operations only available for a given object type. In particular embodiments, the system call 114 may comprise the object handle 112 to the kernel object 106. When the kernel 102 receives the system call 114 from the process 104, the kernel 102 may access data associated with the object handle 112. The kernel 102 may access the data from a memory space allocated to the kernel 102. The accessed data may identify the object type of the kernel object 106 and specify a bit string. In particular embodiments, the kernel 102 may use the object type and the bit string to identify a list of capabilities of the process 104. In particular embodiments, for each object type there may be a corresponding list of capabilities. As an example and not by way of limitation, the list of capabilities for a thread may be represented by a handle table that includes a capability for each bit of the bit string. For instance, the list of capabilities may indicate that the first bit number corresponds to a read capability, the second bit number corresponds to a write capability, and so on. If the bit string has the first two bits “10 . . . ”, then that would be indicative of the process 104 having the capability to read the kernel object 106, but not the capability to write to the kernel object 106. In particular embodiments, each capability in the list may indicate whether the process 104 has permission to perform a predetermined operation (e.g., read/write, etc.) on the kernel object 106. In particular embodiments, particular object types may have capabilities that are specific to that particular object type. In particular embodiments, the kernel 102 may determine whether the process 104 has permission to perform the operation on the kernel object 106. The kernel 102 may determine whether the process 104 has permission by comparing the operation to the list of capabilities. As an example and not by way of limitation, the operation may be a read operation and the kernel 102 may identify whether the process 104 has permission based on the bit string. If the bit number associated with the capability of a read operation is “1” then the kernel 102 may determine that the process 104 has permission to perform the read operation. Otherwise, the kernel 102 may deny the process 104 from performing the operation. In particular embodiments, the kernel 102 may send a response 116 to the process 104 indicating whether or not it has permission to perform the operation. In particular embodiments, the kernel 102 may send no response 116 in response to determining the process 104 does not have permission to perform the operation. If the kernel 102 determines that the process 104 has permission to perform the operation, the process 104 may perform the operation on the kernel object 106 or the kernel may perform the operation on the kernel object 106. In particular embodiments, the kernel 102 may communicate/access the kernel object 106 through the link 120. In particular embodiments, the kernel 102 may send any communications regarding the operation to the process 104 through the link 110. In particular embodiments, the process 104 may communicate/access the kernel object 106 through link 130 to perform the operation.

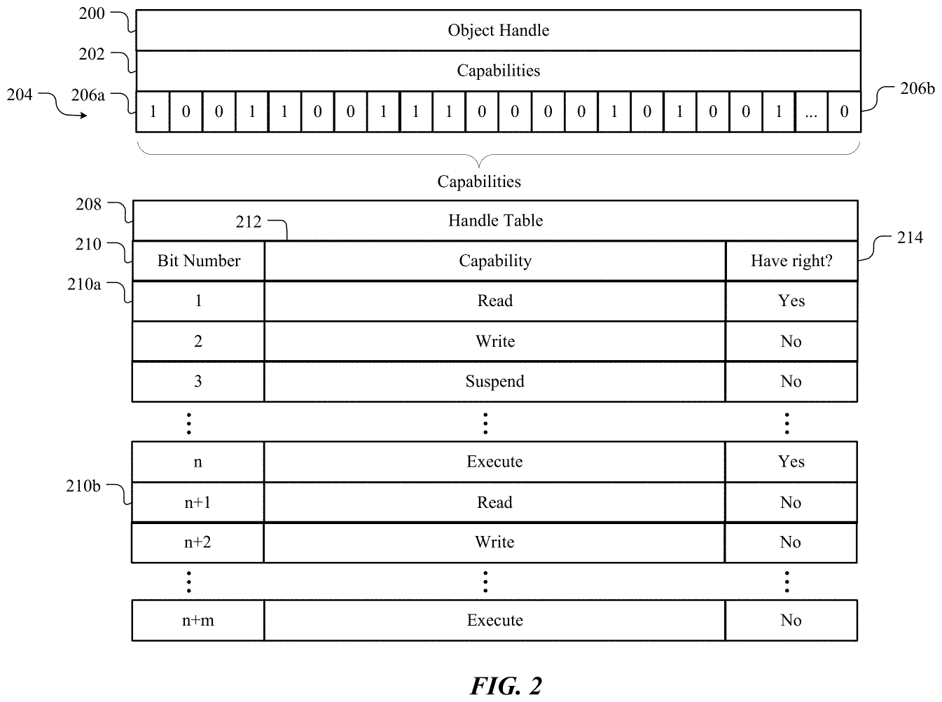

Referring to FIG. 2, an example object handle 200 and its corresponding handle table 208 is shown. In particular embodiments, the object handle 200 may be sent with a system call from a process to a kernel to request to perform an operation. In particular embodiments, the object handle 200 may have a list of capabilities 202 for all object types. As an example and not by way of limitation, the object handle 200 may have a list of capabilities 202 for a thread object type, a process object type, an interrupt object type, and so on. The capabilities 202 may indicate whether the process has the right to perform an operation. In particular embodiments, the object handle 200 may be for a kernel object. The kernel object may be one of a thread, a process, or an interrupt. In particular embodiments, the object handle 200 may comprise a bit string 204 that comprises bits 206 corresponding to the capabilities 202. In particular embodiments, the object handle 200 may be generated for a process by a kernel when a kernel object associated with the object handle 200 is generated. As an example and not by way of limitation, a process may send a system call to a kernel, which generates a kernel object. The kernel may also generate an object handle to the kernel object to send to the process. The capabilities may be determined based on which operations the process requires to function.

In particular embodiments, the object handle 200 may have its corresponding handle table 208 that identifies which capabilities 202 that a process may have. In particular embodiments, the handle table 208 may comprise a bit number 210, a capability 212, and an indication of whether the process has the right 214 to perform the operation. In particular embodiments, the bit number 210 may reflect the order the bit 206 is in the bit string 204. As an example and not by way of limitation, the bit number 210a may correspond to the first bit 206a. In particular embodiments, each capability 212 may correspond to a different capability 212 or operation for each bit number 210. The handle table 208 may determine whether the process has the right 214 to perform an operation based on the bit string 204 compared to the bit number 210. As an example and not by way of limitation, since the bit 206a is a “1” for the bit number 1, the process would be allowed to perform the read operation. In particular embodiments, the object handle 200 may have a bit string 204 that corresponds to a bit string 204 associated with capabilities 212 for multiple objects. As an example and not by way of limitation, the bits 206 from bit number 210a to one before bit number 210b may correspond to capabilities 212 for a particular object type. The remainder bits 206 may correspond to capabilities 212 for another object type. Although only capabilities 212 of two object types are shown, any number of capabilities 212 for other object types may be included in the object handle 200. In particular embodiments, the object handle 200 may have a whole bit string of “0”s for the capabilities 212 for an object type. As such, the bit string 204 may have a large number of bits 206 that may not be necessary. As an example and not by way of limitation, since the object handle 200 may be associated with a thread, the bits 206 corresponding to capabilities 212 for a process may be represented by a bit string of “0”s. In particular embodiments, the object handle 200 may comprise other bits 206 in the bit string 204 that are not related to the capabilities 202. In particular embodiments, the object handle 200 may comprise one or more of a magic, a generation, and an offset. In particular embodiments, a magic may be a randomly generated number. The randomly generated number may be generated in any suitable way. In particular embodiments, the generation may be a predetermined number to detect the offset. In particular embodiments, the magic, the generation, and the offset may correspond to bits 206 outside of the capabilities 202.

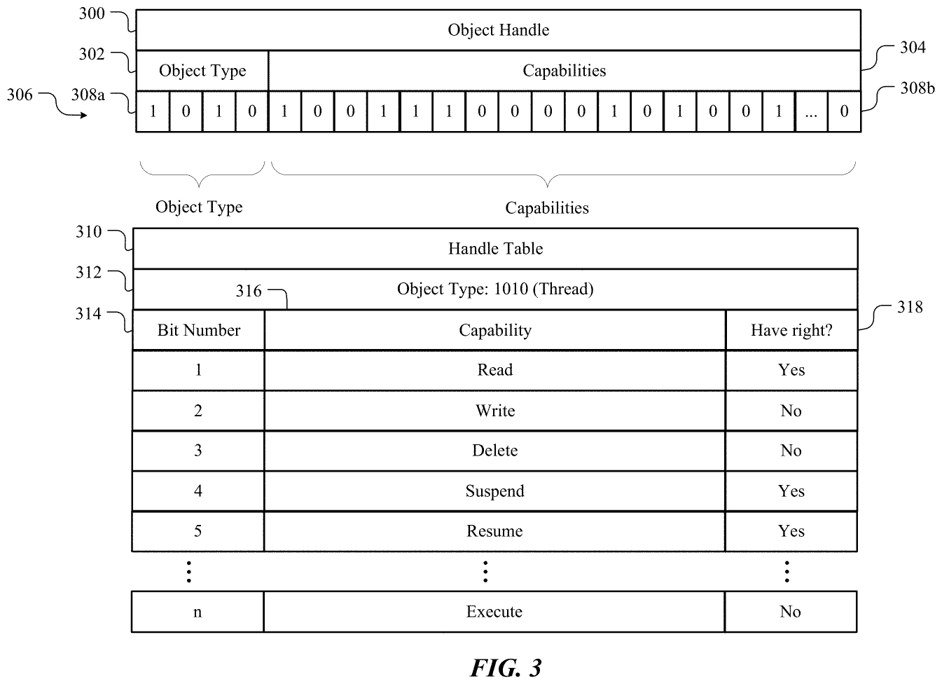

Referring to FIG. 3, another example object handle 300 and its corresponding handle table 310 is shown. In particular embodiments, the object handle 300 may comprise data associated with an object type 302 and a list of capabilities 304. In particular embodiments, the object handle 300 may comprise a bit string 306 that corresponds to the object type 302 and the list of capabilities 304. As an example and not by way of limitation, the first four bits 308 of the bit string 306 may correspond to the object type 302. Although the object type 302 is shown to be represented by the first four bits 308, the object type 302 may be represented by any number of bits 308. In particular embodiments, there may be a table of object types that a kernel may use to determine what the bits 308 that correspond to the object type 302 indicates is the object type 302. As an example and not by way of limitation, the four bits 308 corresponding to the object type 302 may indicate the object type 302 is a thread. The kernel may determine this based on identifying the bit sequence “1010” is associated with a thread object type.

In particular embodiments, the object handle 300 may have its corresponding handle table 310 that identifies which capabilities 304 that a process may have. The object table 310 may have a corresponding object type 312 that indicates what the object type 312 of the kernel object associated with the object handle 300. In particular embodiments, the handle table 310 may comprise a bit number 314, a capability 316, and an indication of whether the process has the right 318 to perform the operation. In particular embodiments, the bit number 314 may reflect the order the bit 308 is in the bit string 306. In particular embodiments, each capability 316 may correspond to a different capability 316 or operation for each bit number 314. Similarly to handle table 208, the handle table 310 may determine whether the process has the right 318 to perform an operation based on the bit string 306 compared to the bit number 314. In particular embodiments, the capabilities 316 may include only capabilities to perform operations specific to the object type 312, which would be a thread object type. Thereby reducing the number of bits 308 within the bit string 306 of the object handle 300 as compared to the bits 206 of the bit string 204. The reduction in the number of bits reduces the aggregated memory requirement and in turn to conserve power consumption. In particular embodiments, there may be operations specific to a thread object type. As an example and not by way of limitation, a suspend operation and a resume operation may be specific to a thread object type.

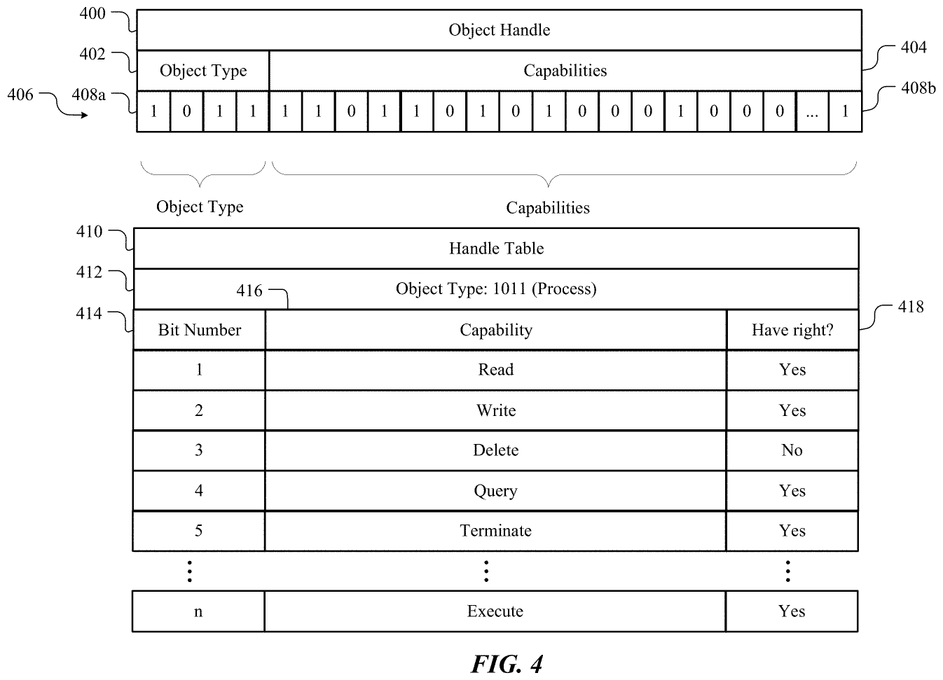

Referring to FIG. 4, another example object handle 400 and its corresponding handle table 410 is shown. In particular embodiments, the object handle 400 may comprise data associated with an object type 402 and a list of capabilities 404. In particular embodiments, the object handle 400 may comprise a bit string 406 that corresponds to the object type 402 and the list of capabilities 404. As an example and not by way of limitation, the first four bits 408 of the bit string 406 may correspond to the object type 402. Although the object type 402 is shown to be represented by the first four bits 408, the object type 402 may be represented by any number of bits 408. In particular embodiments, a kernel may use a table of object types to determine what the bits 408 that correspond to the object type 402 indicates is the object type 402. As an example and not by way of limitation, the four bits 408 corresponding to the object type 402 may indicate the object type 402 is a process. The kernel may determine this based on identifying the bit sequence “1011” is associated with a process object type.

In particular embodiments, the object handle 400 may have its corresponding handle table 410 that identifies which capabilities 404 that a process may have. The object table 410 may have a corresponding object type 412 that indicates what the object type 412 of the kernel object associated with the object handle 400. In particular embodiments, the handle table 410 may comprise a bit number 414, a capability 416, and an indication of whether the process has the right 418 to perform the operation. In particular embodiments, the bit number 414 may reflect the order the bit 408 is in the bit string 406. In particular embodiments, each capability 416 may correspond to a different capability 416 or operation for each bit number 414. Similarly to handle table 208, the handle table 410 may determine whether the process has the right 418 to perform an operation based on the bit string 406 compared to the bit number 414. In particular embodiments, the capabilities 416 may include only capabilities to perform operations specific to the object type 412, which would be a process object type. Thereby reducing the number of bits 408 within the bit string 406 of the object handle 400 as compared to the bits 206 of the bit string 204 similarly to object handle 300. In particular embodiments, there may be operations specific to a process object type. As an example and not by way of limitation, a query operation and a terminate operation may be specific to a process object type.

In particular embodiments, a process may send multiple system calls comprising different object handles associated with two kernel objects of different object types. Each of the object handles for the two different kernel objects may have a different list of capabilities. As an example and not by way of limitation, one object handle may be represented by the object handle 300 of FIG. 3 and the other object handle may be represented by the object handle 400 of FIG. 4.

In particular embodiments, a kernel may duplicate an object handle of a kernel object to generate a second object handle to pass to another process. If for instance, an object handle was generated for a process with full rights, the kernel may duplicate the object handle and allocate a memory space to the kernel for data associated with the duplicated object handle. The data associated with the duplicated object handle may identify the object type of the kernel object and specify a bit string corresponding to the list of capabilities. The kernel may then proceed to send the duplicated object handle to another process. In particular embodiments, the kernel may modify the bit string of the object handle prior to sending the duplicated object handle to another process. In particular embodiments, the kernel may reduce the amount of permissions to perform operations on the kernel object. As an example and not by way of limitation, if an object handle originally has read and write capabilities, the kernel may remove the write capability and send the object handle to another process with only the read capability for the kernel object. In particular embodiments, the kernel may increase the amount of permissions to perform operations on the kernel object for the duplicated object handle prior to sending the duplicated object handle. As an example and not by way of limitation, the kernel may add a write capability to the object handle and send the object handle to another process with the write capability for the kernel object. In particular embodiments, the kernel may identify which operations a process needs to function in order to modify the bit string associated with the duplicated object handle. As an example and not by way of limitation, if a process only needs to be able to perform a read operation on a kernel object, then the kernel may duplicate an object handle and remove other capabilities and leave only the capability to perform the read operation. In particular embodiments, the duplication of the object handle would retain the bit string associated with the object type.

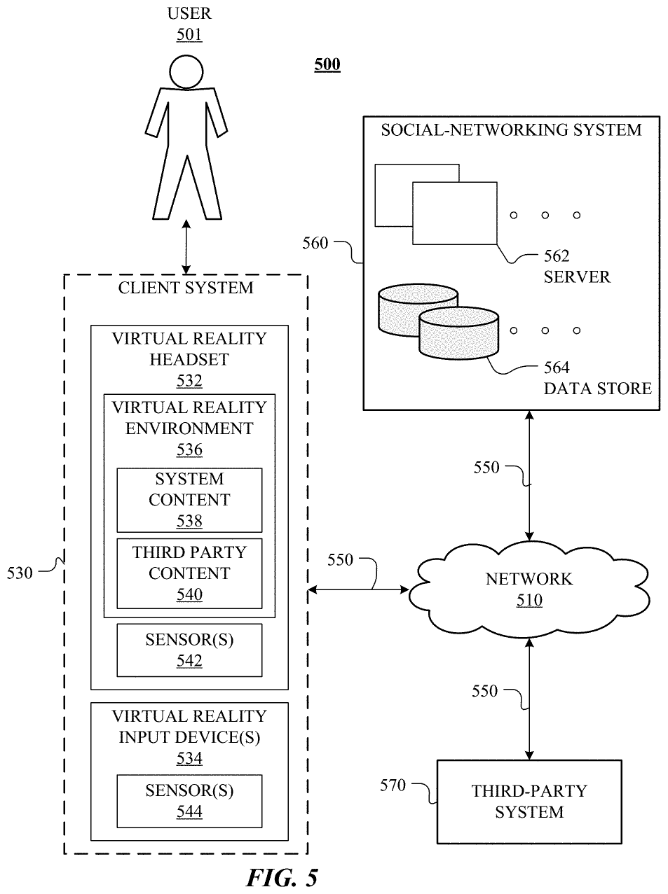

FIG. 5 illustrates an example network environment 500 associated with a virtual reality system. Network environment 500 includes a user 501 interacting with a client system 530, a social-networking system 560, and a third-party system 570 connected to each other by a network 510. Although FIG. 5 illustrates a particular arrangement of a user 501, a client system 530, a social-networking system 560, a third-party system 570, and a network 510, this disclosure contemplates any suitable arrangement of a user 501, a client system 530, a social-networking system 560, a third-party system 570, and a network 510. As an example and not by way of limitation, two or more of a user 501, a client system 530, a social-networking system 560, and a third-party system 570 may be connected to each other directly, bypassing a network 510. As another example, two or more of a client system 530, a social-networking system 560, and a third-party system 570 may be physically or logically co-located with each other in whole or in part. Moreover, although FIG. 5 illustrates a particular number of users 501, client systems 530, social-networking systems 560, third-party systems 570, and networks 510, this disclosure contemplates any suitable number of client systems 530, social-networking systems 560, third-party systems 570, and networks 510. As an example and not by way of limitation, network environment 500 may include multiple users 501, client systems 530, social-networking systems 560, third-party systems 570, and networks 510.

This disclosure contemplates any suitable network 510. As an example and not by way of limitation, one or more portions of a network 510 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 510 may include one or more networks 510.

Links 550 may connect a client system 530, a social-networking system 560, and a third-party system 570 to a communication network 510 or to each other. This disclosure contemplates any suitable links 550. In particular embodiments, one or more links 550 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 550 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 550, or a combination of two or more such links 550. Links 550 need not necessarily be the same throughout a network environment 500. One or more first links 550 may differ in one or more respects from one or more second links 550.

In particular embodiments, a client system 530 may be an electronic device including hardware, software, or embedded logic components or a combination of two or more such components and capable of carrying out the appropriate functionalities implemented or supported by a client system 530. As an example and not by way of limitation, a client system 530 may include a computer system such as a desktop computer, notebook or laptop computer, netbook, a tablet computer, e-book reader, GPS device, camera, personal digital assistant (PDA), handheld electronic device, cellular telephone, smartphone, virtual reality headset and controllers, other suitable electronic device, or any suitable combination thereof. This disclosure contemplates any suitable client systems 530. A client system 530 may enable a network user at a client system 530 to access a network 510. A client system 530 may enable its user to communicate with other users at other client systems 530. A client system 530 may generate a virtual reality environment for a user to interact with content.

In particular embodiments, a client system 530 may include a virtual reality (or augmented reality) headset 532, such as OCULUS RIFT and the like, and virtual reality input device(s) 534, such as a virtual reality controller. A user at a client system 530 may wear the virtual reality headset 532 and use the virtual reality input device(s) to interact with a virtual reality environment 536 generated by the virtual reality headset 532. Although not shown, a client system 530 may also include a separate processing computer and/or any other component of a virtual reality system. A virtual reality headset 532 may generate a virtual reality environment 536, which may include system content 538 (including but not limited to the operating system), such as software or firmware updates and also include third-party content 540, such as content from applications or dynamically downloaded from the Internet (e.g., web page content). A virtual reality headset 532 may include sensor(s) 542, such as accelerometers, gyroscopes, magnetometers to generate sensor data that tracks the location of the headset device 532. The headset 532 may also include eye trackers for tracking the position of the user's eyes or their viewing directions. The client system may use data from the sensor(s) 542 to determine velocity, orientation, and gravitation forces with respect to the headset. Virtual reality input device(s) 534 may include sensor(s) 544, such as accelerometers, gyroscopes, magnetometers, and touch sensors to generate sensor data that tracks the location of the input device 534 and the positions of the user's fingers. The client system 530 may make use of outside-in tracking, in which a tracking camera (not shown) is placed external to the virtual reality headset 532 and within the line of sight of the virtual reality headset 532. In outside-in tracking, the tracking camera may track the location of the virtual reality headset 532 (e.g., by tracking one or more infrared LED markers on the virtual reality headset 532). Alternatively or additionally, the client system 530 may make use of inside-out tracking, in which a tracking camera (not shown) may be placed on or within the virtual reality headset 532 itself. In inside-out tracking, the tracking camera may capture images around it in the real world and may use the changing perspectives of the real world to determine its own position in space.

Third-party content 540 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at a client system 530 may enter a Uniform Resource Locator (URL) or other address directing a web browser to a particular server (such as server 562, or a server associated with a third-party system 570), and the web browser may generate a Hyper Text Transfer Protocol (HTTP) request and communicate the HTTP request to server. The server may accept the HTTP request and communicate to a client system 530 one or more Hyper Text Markup Language (HTML) files responsive to the HTTP request. The client system 530 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the social-networking system 560 may be a network-addressable computing system that can host an online social network. The social-networking system 560 may generate, store, receive, and send social-networking data, such as, for example, user-profile data, concept-profile data, social-graph information, or other suitable data related to the online social network. The social-networking system 560 may be accessed by the other components of network environment 500 either directly or via a network 510. As an example and not by way of limitation, a client system 530 may access the social-networking system 560 using a web browser of a third-party content 540, or a native application associated with the social-networking system 560 (e.g., a mobile social-networking application, a messaging application, another suitable application, or any combination thereof) either directly or via a network 510. In particular embodiments, the social-networking system 560 may include one or more servers 562. Each server 562 may be a unitary server or a distributed server spanning multiple computers or multiple datacenters. Servers 562 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 562 may include hardware, software, or embedded logic components or a combination of two or more such components for carrying out the appropriate functionalities implemented or supported by server 562. In particular embodiments, the social-networking system 560 may include one or more data stores 564. Data stores 564 may be used to store various types of information. In particular embodiments, the information stored in data stores 564 may be organized according to specific data structures. In particular embodiments, each data store 564 may be a relational, columnar, correlation, or other suitable database. Although this disclosure describes or illustrates particular types of databases, this disclosure contemplates any suitable types of databases. Particular embodiments may provide interfaces that enable a client system 530, a social-networking system 560, or a third-party system 570 to manage, retrieve, modify, add, or delete, the information stored in data store 564.

In particular embodiments, the social-networking system 560 may store one or more social graphs in one or more data stores 564. In particular embodiments, a social graph may include multiple nodes—which may include multiple user nodes (each corresponding to a particular user) or multiple concept nodes (each corresponding to a particular concept)—and multiple edges connecting the nodes. The social-networking system 560 may provide users of the online social network the ability to communicate and interact with other users. In particular embodiments, users may join the online social network via the social-networking system 560 and then add connections (e.g., relationships) to a number of other users of the social-networking system 560 whom they want to be connected to. Herein, the term “friend” may refer to any other user of the social-networking system 560 with whom a user has formed a connection, association, or relationship via the social-networking system 560.

In particular embodiments, the social-networking system 560 may provide users with the ability to take actions on various types of items or objects, supported by the social-networking system 560. As an example and not by way of limitation, the items and objects may include groups or social networks to which users of the social-networking system 560 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 560 or by an external system of a third-party system 570, which is separate from the social-networking system 560 and coupled to the social-networking system 560 via a network 510.

In particular embodiments, the social-networking system 560 may be capable of linking a variety of entities. As an example and not by way of limitation, the social-networking system 560 may enable users to interact with each other as well as receive content from third-party systems 570 or other entities, or to allow users to interact with these entities through an application programming interfaces (API) or other communication channels.

In particular embodiments, a third-party system 570 may include one or more types of servers, one or more data stores, one or more interfaces, including but not limited to APIs, one or more web services, one or more content sources, one or more networks, or any other suitable components, e.g., that servers may communicate with. A third-party system 570 may be operated by a different entity from an entity operating the social-networking system 560. In particular embodiments, however, the social-networking system 560 and third-party systems 570 may operate in conjunction with each other to provide social-networking services to users of the social-networking system 560 or third-party systems 570. In this sense, the social-networking system 560 may provide a platform, or backbone, which other systems, such as third-party systems 570, may use to provide social-networking services and functionality to users across the Internet.

In particular embodiments, a third-party system 570 may include a third-party content object provider. A third-party content object provider may include one or more sources of content objects, which may be communicated to a client system 530. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 560 also includes user-generated content objects, which may enhance a user's interactions with the social-networking system 560. User-generated content may include anything a user can add, upload, send, or “post” to the social-networking system 560. As an example and not by way of limitation, a user communicates posts to the social-networking system 560 from a client system 530. Posts may include data such as status updates or other textual data, location information, photos, videos, links, music or other similar data or media. Content may also be added to the social-networking system 560 by a third-party through a “communication channel,” such as a newsfeed or stream.

In particular embodiments, the social-networking system 560 may include a variety of servers, sub-systems, programs, modules, logs, and data stores. In particular embodiments, the social-networking system 560 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 560 may also include suitable components such as network interfaces, security mechanisms, load balancers, failover servers, management-and-network-operations consoles, other suitable components, or any suitable combination thereof. In particular embodiments, the social-networking system 560 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 560 to one or more client systems 530 or one or more third-party systems 570 via a network 510. The web server may include a mail server or other messaging functionality for receiving and routing messages between the social-networking system 560 and one or more client systems 530. An API-request server may allow a third-party system 570 to access information from the social-networking system 560 by calling one or more APIs. An action logger may be used to receive communications from a web server about a user's actions on or off the social-networking system 560. In conjunction with the action log, a third-party-content-object log may be maintained of user exposures to third-party-content objects. A notification controller may provide information regarding content objects to a client system 530. Information may be pushed to a client system 530 as notifications, or information may be pulled from a client system 530 responsive to a request received from a client system 530. Authorization servers may be used to enforce one or more privacy settings of the users of the social-networking system 560. A privacy setting of a user determines how particular information associated with a user can be shared. The authorization server may allow users to opt in to or opt out of having their actions logged by the social-networking system 560 or shared with other systems (e.g., a third-party system 570), such as, for example, by setting appropriate privacy settings. Third-party-content-object stores may be used to store content objects received from third parties, such as a third-party system 570. Location stores may be used for storing location information received from client systems 530 associated with users. Advertisement-pricing modules may combine social information, the current time, location information, or other suitable information to provide relevant advertisements, in the form of notifications, to a user.

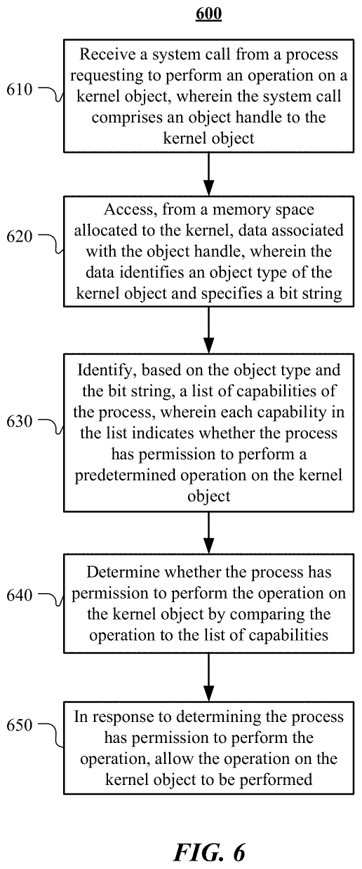

FIG. 6 illustrates an example method 600 for handling a system call from a process. The method may begin at step 610, where a kernel of an operating system executing on a computing system (e.g., augmented reality system or virtual reality system) may receive a system call from a process requesting to perform an operation on a kernel object. In particular embodiments, the system call may comprise an object handle to the kernel object. At step 620, the kernel may access, from a memory space allocated to the kernel, data associated with the object handle. In particular embodiments, the data may identify an object type of the kernel object and specify a bit string. At step 630, the kernel may identify, based on the object type and the bit string, a list of capabilities of the process. In particular embodiments, each capability in the list may indicate whether the process has permission to perform a predetermined operation on the kernel object. At step 640, the kernel may determine whether the process has permission to perform the operation on the kernel object by comparing the operation to the list of capabilities. At step 650, the kernel may, in response to determining the process has permission to perform the operation, allow the operation on the kernel object to be performed. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for handling a system call from a process, including the particular steps of the method of FIG. 6, this disclosure contemplates any suitable method of handling a system call from a process, including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

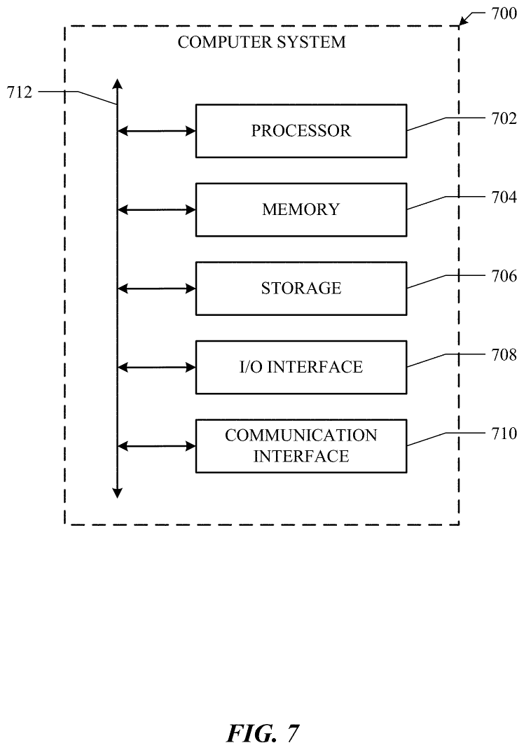

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a kernel of an operating system executing on a computing system:
receiving a system call from a process requesting to perform an operation on a kernel object, wherein the system call comprises an object handle to the kernel object;
accessing, from a memory space allocated to the kernel, data associated with the object handle, wherein the data identifies an object type of the kernel object and specifies a bit string;
identifying, based on the object type and the bit string, a list of capabilities of the process, wherein each capability in the list indicates whether the process has permission to perform a predetermined operation on the kernel object;
determining whether the process has permission to perform the operation on the kernel object by comparing the operation to the list of capabilities; and
in response to determining the process has permission to perform the operation, allowing the operation on the kernel object to be performed.

2. The method of claim 1, wherein the kernel object is one of a thread, a process, or an interrupt.

3. The method of claim 1, wherein the object handle is generated by the kernel for the process when the kernel object is generated.

4. The method of claim 1, further comprising:
receiving a second system call from the process requesting to perform a second operation on a second kernel object, wherein the second system call comprises a second object handle to a second kernel object;
accessing, from a second memory space allocated to the kernel, a second data associated with the second object handle, wherein the second data identifies a second object type of the second kernel object and specifies a second bit string;
identifying, based on the second object type and the second bit string, a second list of capabilities of the process;
determining whether the process has permission to perform a second operation on the second kernel object by comparing the second operation to the second list of capabilities; and
in response to determining the process has permission to perform the second operation, allowing the second operation on the second kernel object to be performed.

5. The method of claim 4, wherein the object type is different from the second object type, and wherein the list of capabilities for the object type is different from the second list of capabilities for the second object type.

6. The method of claim 1, wherein the object handle comprises one or more of a magic, a generation, and an offset, wherein the magic is a randomly generated number, and wherein the generation is a predetermined number to detect the offset.

7. The method of claim 1, wherein the object type is represented by a second bit string, and wherein identifying the object type is based on a comparison of the second bit string to a table of bit strings corresponding to a plurality of object types.

8. The method of claim 1, wherein the operation comprises one of a suspend operation, a resume operation, a query operation, or a terminate operation.

9. The method of claim 1, further comprising:
duplicating the object handle to generate a second object handle to pass to a second process;
allocating a second memory space to the kernel for a second data associated with the second object handle, wherein the second data identifies the object type of the kernel object and specifies a second bit string; and
sending, to the second process, the second object handle.

10. The method of claim 9, further comprising:
modifying the second bit string associated with the second object handle, wherein the second bit string corresponds to a second list of capabilities of the second process.

11. The method of claim 10, wherein modifying the second bit string associated with the second object handle comprises reducing the amount of permissions to perform operations on the kernel object.

12. The method of claim 10, wherein modifying the second bit string associated with the second object handle comprises increasing the amount of permissions to perform operations on the kernel object.

13. The method of claim 10, wherein modifying the second bit string associated with the second object handle is based on identifying one or more operations the second process requires to function.

14. One or more computer-readable non-transitory storage media embodying software that is operable when executed to:
receive a system call from a process requesting to perform an operation on a kernel object, wherein the system call comprises an object handle to the kernel object;
access, from a memory space allocated to the kernel, data associated with the object handle, wherein the data identifies an object type of the kernel object and specifies a bit string;
identify, based on the object type and the bit string, a list of capabilities of the process, wherein each capability in the list indicates whether the process has permission to perform a predetermined operation on the kernel object;
determine whether the process has permission to perform the operation on the kernel object by comparing the operation to the list of capabilities; and
in response to determining the process has permission to perform the operation, allow the operation on the kernel object to be performed.

15. A system comprising: one or more processors; and a non-transitory memory coupled to the processors comprising instructions executable by the processors, the processors operable when executing the instructions to:
receive a system call from a process requesting to perform an operation on a kernel object, wherein the system call comprises an object handle to the kernel object;
access, from a memory space allocated to the kernel, data associated with the object handle, wherein the data identifies an object type of the kernel object and specifies a bit string;
identify, based on the object type and the bit string, a list of capabilities of the process, wherein each capability in the list indicates whether the process has permission to perform a predetermined operation on the kernel object;
determine whether the process has permission to perform the operation on the kernel object by comparing the operation to the list of capabilities; and
in response to determining the process has permission to perform the operation, allow the operation on the kernel object to be performed.
